(19) United States
(12) Patent Application Publication
(10) Pub. No.: US 2013/0113657 A1
(43) Pub. Date: May 9, 2013

(54) SYSTEMS AND METHODS TO INCREASE THE NUMBER OF SIMULTANEOUS PIXELS IN A WIRELESS IMAGING SYSTEM

(71) Applicants: Farbod Behbahani, Irvine, CA (US); Vipul Jain, Irvine, CA (US)

(72) Inventors: Farbod Behbahani, Irvine, CA (US); Vipul Jain, Irvine, CA (US)

(73) Assignee: SABERTEK INC., Irvine, CA (US)

(21) Appl. No.: 13/461,683

(22) Filed: May 1, 2012

Related U.S. Application Data
(63) Continuation of application No. 61/482,373, filed on May 4, 2011.

(51) Int. Cl. H01Q 3/40

(52) U.S. Cl. CPC H01Q 3/40
USPC 342/373

(57) ABSTRACT

A phased array receiver having beam-forming capability, with M inputs and N outputs, includes M radio-frequency (RF) front-ends, each comprising an RF amplifier; and a beam-forming network, with M input ports and N output ports, each coupled to at least one of the other ports through an electrical network, and wherein a signal at each port has a predetermined phase or delay relative to the signals at the other ports, and wherein M is smaller than or equal to N.

This application claims priority to Provisional Application Serial No. 61/482373, filed May 4, 2011, the content of which is incorporated by reference.

### BACKGROUND

The present invention relates to systems and methods for high resolution wireless imaging systems.

Passive imaging sensors operating in millimeter-wave atmospheric windows can capture images through obstacles such as fog, clouds, smoke and clothing. This unique feature enables several important applications including theft prevention, low-visibility airplane-landing, concealed weapon detection, covert terrestrial and aerial surveillance, highway traffic monitoring and precision targeting. Existing electronics technologies for passive imaging are bulky, expensive and require complicated moving mechanical components to meet performance requirements. There is a clear need for novel solutions that can significantly reduce the size, weight, power dissipation and cost (SWAP-C) of passive imaging sensors while improving the performance and image quality. Such light-weight, low-power solutions will lead to a paradigm shift in the state-of-the-art and will enable new non-intrusive products such as hand-held imagers for port security, helmet-mounted imagers for the warfighter and compact imagers mounted on unmanned aerial vehicles (UAVs).

State-of-the-art imagers are currently built using an array of receivers, each an assembly of several discrete compound-semiconductor (III-V) integrated circuits (ICs). In order to generate thousands of image pixels, either thousands of these receivers must be used in a staring array or a smaller array must be scanned (either mechanically or electronically) sequentially to generate the entire image. These architectures are bulky and expensive due to either a large number of electronic components (staring arrays) or additional mechanical components (scanned imagers). Novel multi-pixel architectures for passive imaging need to be developed to reduce power consumption and size of the imager. These architectures will obviate the need for any mechanical or electronic scanning components and will dramatically reduce the component count, system size and cost, while significantly improving the image quality.

In one aspect, a beam-forming network includes a plurality of input and output ports, each coupled to at least one of the other ports through an electrical network, such that the signal at each port has a given phase or delay relative to the signals at the other ports.

In another aspect, a phased array receiver having beam-forming capability, with M inputs and N outputs, includes M radio-frequency (RF) front-ends, each comprising an RE amplifier; and a beam-forming network, with M input ports and N output ports, each coupled to at least one of the other ports through an electrical network, and wherein a signal at each port has a predetermined phase or delay relative to the signals at the other ports, and wherein M is smaller than or equal to N.

Implementations of the above aspect can include one or more of the following. The input ports and output ports can be interchanged, and the number of input ports can be smaller than, larger than or the same as the number of output ports. Each of the electrical networks can have a plurality of phase shifters or delay elements; zero or more power splitters and power combiners; and zero or more amplifiers. The phase shifters or delay elements can include passive components, including but not limited to, physical transmission lines, artificial transmission lines, resistors, capacitors and inductors; and/or active components, including hut not limited to, transistors. The power splitters and power combiners can include passive components, including but not limited to, physical transmission lines, artificial transmission lines, resistors, capacitors and inductors; and/or active components, including but not limited to, transistors. The phase shifts of the phase shifters, or delays of the delay elements, may be either fixed or independently tunable (variable). The phase shift or delay may be tunable continuously using an analog control signal or in discrete steps using digital control signals. The gains of the amplifiers may be fixed or independently tunable (variable). The gains may be tunable continuously using an analog control signal or in discrete steps using digital control signals. The beam-forming network is formed completely or partially on one or more integrated circuit chips/substrates, including but not limited to, silicon (CMOS), silicon-germanium (SiGe CMOS/BiCMOS), silicon-on-insulator (SOI CMOS), GaAs, InGaAs, InP, and silicon-on-sapphire. The signal frequency at the input and output ports can be anywhere between 2 GHz and 300 GHz. The signal frequency at the input and output ports ea be for the imaging/communications bands in the millimeter-wave or EHF (30-300 GHz) spectrum, in particular 20-30 GHz (K band), 50-70 GHz (V band), 70-110 GHz (W band), 140 GHz (D band) and 220 GHz (G band).

In another aspect, a phased array receiver having beam-forming capability comprising the beam-forming network of claim 1, wherein the number of output ports of the beam-forming network is the same as or higher than the number of input ports of the receiver and the beam-forming network.

Implementations of the above aspect may include one or more of the following. The system includes a plurality of RF front-ends, each with an RF amplifier. The output of each of the RF front-ends is electrically connected to a separate input of the beam-forming network. The input of each of the RF front-ends is electrically connected to a separate antenna. The gains of the RF front-ends may be fixed or independently tunable (variable). The gains may be tunable continuously using an analog control signal or in discrete steps using digital control signals. Each of the outputs of the beam-forming network is electrically connected to additional circuits, including but not limited to, amplifiers, down-converting mixers and power/rms detectors. A plurality of analog-to-digital converters, such that the output of the receiver may be analog, digital, or both, wherein the number of analog-to-digital-converters may be the same as or lower than the number of antennas. A multi-channel analog-to-digital converter can be used, such that the output of the receiver may be analog, digital, or both. The phase shifters (or delay elements) and the amplifiers in the beam-forming network, and the amplifiers in the RF front-ends can be configured such that the signal from a certain direction has the highest gain, The direction in which the signal has the maximum gain can be tuned by varying the phase shifts (or delays) of the phase shifters (or delay elements) and the gains of the amplifiers in the beam-forming network, and/or the gains of the RF front-ends. The phase shifters (or delay elements) and the amplifiers in the beam-forming network, and the amplifiers in the RF front-ends are configured such that the signals from two or more different directions have much higher gains than the signals from other directions. The phase shifters (or delay elements) and the amplifiers in the beam-forming network, and the amplifiers in the RF front-ends are configured such that the signals at the output ports of the beam-forming network have maximum gain from different directions in space. As a result, the space solid-angle is divided into sub-sections (or beams), and the signal incident on each of these sub-sections is processed by the RF front end and the beam-forming network, and appears at one of the output ports of the beam-forming network. A digital processing unit can calibrate the direction of the incoming signal by configuring the phase shifts (or delays) of the phase shifters (or delay elements) and the gains of the amplifiers in the beam-forming network, and/or the gains of the RF front-ends. The digital processing unit further includes the capability to remove the correlation among signals incident from different directions in the space, by calibrating the phase shifts (or delays) of the phase shifters (or delay elements) and the gains of the amplifiers in the beam-forming network, and/or the gains of the RF front ends. The phased array receiver is formed completely or partially on one or more integrated circuit chips/substrates, including but not limited to, silicon (CMOS), silicon-germanium (SiGe CMOS/BiCMOS), silicon-on-insulator (SOI CMOS), GaAs, InGaAs, InP, and silicon-on-sapphire. The antennas may be located on the same die, or in the same package as the receiver. Additional passive and active components can be used in the package, including but not limited to, matching networks, amplifiers and multi-throw switches. The signal frequency at the input and output ports is anywhere between 2 GHz and 300 GHz, The signal frequency at the input and output ports is limited to the imaging/communications bands in the millimeter-wave or EHF (30-300 GHz) spectrum, in particular 20-30 GHz (K band), 50-70 GHz (V band), 70-110 GHz (W band), 140 GHz (D band) and 220 GHz (G band).

In yet another aspect, a phased array transmitter has beam-forming capability comprising the beam-forming network of claim 1, wherein the number of input ports of the beam-forming network is the same as or higher than the number of output ports of the transmitter and the beam-forming network.

Implementations of the above aspect may include one or more of the following. The transmitter can include a plurality of RF front-ends, each comprising an RF amplifier. The input of each of the RF front-ends is electrically connected to a separate output of the beam-forming network. The output of each of the RF front-ends is electrically connected to a separate antenna. The gains of the RF front-ends may be fixed or independently tunable (variable). The gains may be tunable continuously using an analog control signal or in discrete steps using digital control signals. Each of the inputs of the beam-forming network is electrically connected to additional circuits, including but not limited to, amplifiers, up-converting mixers and modulators. The phase shifters (or delay elements) and the amplifiers in the beam-forming network, and the amplifiers in the RE front-ends are configured such that the signal transmitted in a certain direction has the highest power. The direction in which the transmitted signal has the maximum power can be tuned by varying the phase shifts (or delays) of the phase shifters (or delay elements) and the gains of the amplifiers in the beam-forming network, and/or the gains of the RF front-ends. The phase shifters (or delay elements) and the amplifiers in the beam-forming network, and the amplifiers in the RF front-ends are configured such that the signals in two or more different directions have much higher powers (or amplitudes) than the signals in other directions. The phase shifters (or delay elements) and the amplifiers in the beam-forming network, and the amplifiers in the RF front-ends are configured such that the signals at the output ports of the transmitter have maximum powers (or amplitudes) in different directions in space. As a result, the space solid-angle is divided into sub-sections (or beams), and the signal at each of the input ports of the beam-forming network is processed by the RE front end and the beam-forming network, and is transmitted through one of the sub-sections in space. A digital processing unit can calibrate the direction of the radiated signal by configuring the phase shifts (or delays) of the phase shifters (or delay elements) and the gains of the amplifiers in the beam-forming network, and/or the gains of the RF front-ends. The digital processing unit further includes the capability to remove the correlation among signals radiated in different directions in the space, by calibrating the phase shifts (or delays) of the phase shifters (or delay elements) and the gains of the amplifiers in the beam-forming network, and/or the gains of the RF front-ends. The phased army transmitter is formed completely or partially on one or more integrated circuit chips/substrates, including hut not limited to, silicon (CMOS), silicon-germanium (SiGe CMOS/BiCMOS), silicon-on-insulator (SOI CMOS), GaAs, InGaAs, InP, and silicon-on-sapphire. The antennas may be located on the same die, or in the same package as the receiver. Additional passive and active components can be used in the package, including but not limited to, matching networks, amplifiers and multi-throw switches. The signal frequency at the input and output ports is anywhere between 2 GHz and 300 GHz. The signal frequency at the input and output ports is limited to the imaging/communications bands in the millimeter-wave or EHF (30-300 GHz) spectrum, in particular 20-30 GHz (V band), 50-70 GHz (V band), 70-110 GHz (W band), 140 GHz (D band) and 220 GHz (G band). The signal at each output port of the beam-forming network generates a unit pixel in the image. The number of pixels in the image is the same as or higher than the number of antennas. The transmitter radiates signals in different directions in space simultaneously, that are reflected from the target object and are subsequently incident on the receiver array, which generates a unit pixel at each of the output polls of the beam-forming network in the receiver. The number of pixels in the image is the same as or higher than the number of antennas.

In another aspect, a method to reduce the power consumption and size of a multi-pixel passive or active imaging receiver includes using the receiver array, wherein the number of pixels in the image is higher than the number of antennas. In the method, the number of pixels in the image is higher than the number of antennas.

In yet another aspect, a method to improve the temperature sensitivity (or noise equivalent temperature difference) of a passive or active imager includes increasing the dwell time per pixel by a factor equal to the ratio of the number of pixels to the number of antennas.

Advantages of the system may include one or more of the following. The system significantly reduces the number of ICs by at least a factor of 300, the array power consumption by more than 10 times, and the imager cost and weight by more than 50 times, while proving image quality. The system operates independent of frequency, and in particular can handle W band (75-110 GHz) well.

### BRIEF DESCRIPTION OF THE DRAWINGS

FIG. 1A shows an exemplary scanless imager in accordance with one aspect of the present invention;

FIG. 1B is a block diagram illustrating an exemplary embodiment of a passive imaging receiver array in accordance with the present invention;

FIG. 2 is a schematic illustrating an exemplary embodiment of a 4-antenna receiver in accordance with the present invention;

FIG. 3 shows schematics illustrating several exemplary embodiments of the RF front-end in FIG. 2, in accordance with the present invention;

FIG. 4 shows schematics illustrating several exemplary embodiments of the phase shifter (or delay element) in FIG. 2, in accordance with the present invention;

FIG. 5 shows schematics illustrating several exemplary embodiments of the circuits connected to the labeled nodes of the circuit network in FIG. 2, in accordance with the present invention;

FIG. 6 shows schematics illustrating several exemplary embodiments of the physical arrangement of the semiconductor die and antennas in the package and PCB, in accordance with the present invention;

FIG. 7 is a schematic illustrating an exemplary embodiment of a phased array receiver in accordance with the present invention; and

FIG. 8 is a schematic illustrating an exemplary embodiment of the summing amplifier in FIG. 7.

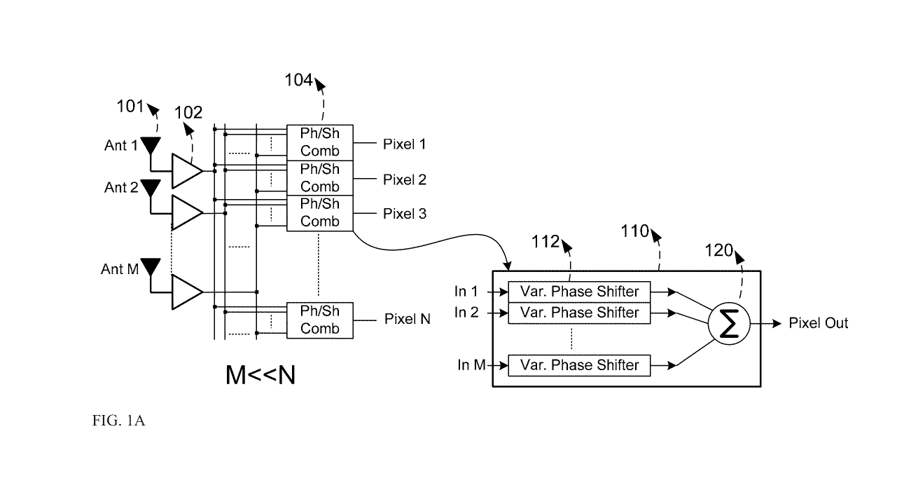

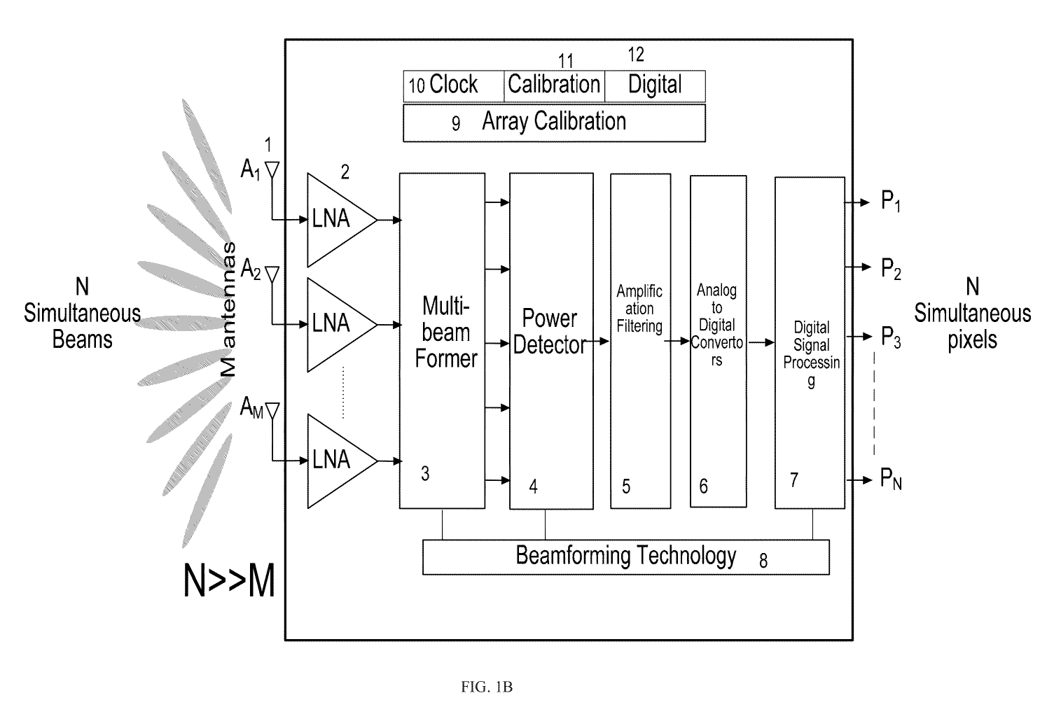

A beam-forming network system called ScanLess IMager (SIAM) is disclosed in FIG. 1A. The SLIM system generates N pixels from M antennas, where N>>M. The system builds on phased-array principles. In a standard phased-array, signals from M antennas are combined with specific phase-shifts and gains to achieve a specific beam direction for the phased-array pattern. By changing the gain and phase of each antenna, the pattern direction can be changed; however, signal in only one direction can be received at a time.

SBR-SLIM expands on the same basic principle so that, instead of one phase-shifter/combiner, a complex phase-shifter/combiner matrix is used to receive signals from N simultaneous beam directions, each representing one image pixel. Therefore, M antennas can generate N pixels, significantly increasing the level of integration, reducing the imager size, and lowering the power consumption per pixel.

Referring now to FIG. 1A, antenna 101 is connected to amplifier such as LNA 102. The amplifier 102 in turn drives a plurality of phase-shifter/combiner matrix 104. The complex phase-shifter/combiner matrix 104 is used to receive signals from N simultaneous beam directions, each representing one image pixel. Therefore, M antennas can generate N significantly increasing the level of integration, reducing the imager size, and lowering the power consumption per pixel. The output of the matrix 104 is provided to module 110 with a plurality of variable phase shifters 112 whose outputs are provided to a summer 120 that generates pixel outputs.

The beam-forming network has a plurality of input and output ports, each coupled to at least one of the other ports through an electrical network, such that the signal at each port has a given phase or delay relative to the signals at the other ports. The input ports and output ports can be interchanged, and the number of input ports can be smaller than, larger than or the same as the number of output ports.

The network can be used in multi-pixel architectures for passive imaging and can be used to reduce power consumption and size of the imager. These architectures will obviate the need for any mechanical or electronic scanning components and will dramatically reduce the component count, system size and cost, while significantly improving the image quality. For instance, a 1-Megapixel image would require about 5×10⁶ ICs using current staring array architectures, However, using SBR-SIAM, the system can reduce the number of ICs by at least a factor of 300, the array power consumption by more than 10 times, and the imager cost and weight by more than 50 times, while improving image quality. All the advantages of multi-beamforming phased arrays can be implemented a single-chip multi-beamforming imaging receiver array with array architecture design, integrated circuit design, on-chip array calibration and high imager sensitivity. For example, one implementation can provide a 4-antenna/16-pixel imaging array on silicon with NETD<0.2K and total power consumption of less than 8 mW/pixel. Further, the antennas can be integrated in the same package resulting in a high level of integration and scalability.

The aforementioned beam-forming network can be used in wireless receivers and transmitters for various applications at frequencies ranging from 2 GHz to 300 GHz. It is highly suitable for use at millimeter-wave (mm-wave) frequencies, especially to realize receivers and transmitters in the extremely high frequency (EHF) spectrum from 30-300 GHz, including 20-30 GHz (K band), 50-70 GHz (V band), 70-110 GHz (W band), 140 GHz (D band) and 220 GHz (G hand). These transmitters and receivers can he used for wireless communication, automotive radars, active/passive imaging and other applications. Exemplary architectures of transmitters and receivers for these applications will be described shortly.

The beam-forming network can be formed completely or partially on one or more integrated circuit chips/substrates, including but not limited to, silicon (CMOS), silicon germanium (SiGe CMOS/BiCMOS), silicon-on-insulator (SOI CMOS), GaAs, InGaAs, MP, and silicon-on-sapphire. Implementation on a silicon substrate can provide the highest level of integration.

A phased array receiver having beam-forming capability can be realized using the beam-forming network described earlier. The number of output ports of the beam-forming network can be the same as or higher than the number of input ports of the receiver (and the beam-forming network). The receiver can optionally include a plurality of RF front-ends, each comprising an RF amplifier chain. The output of each of the RF front-ends is electrically connected to a separate input of the beam-forming network, and the input of each of the RE front-ends is electrically connected to a separate antenna.

The gains of the RE front-ends may be fixed or independently tunable (variable). The gains may be tunable continuously using an analog control signal or in discrete steps using digital control signals. Each of the outputs of the beam-forming network may be electrically connected to additional circuits, including but not limited to, amplifiers, down-converting mixers and power/rms detectors. The receiver may further include a plurality of analog-to-digital converters, such that the output of the receiver may be analog, digital, or both. The number of analog-to-digital-converters may be the same as or lower than the number of antennas. Alternatively, a multi-channel analog-to-digital converter may be employed.

In one embodiment of the phased array receiver, the phase shifters (or delay elements) and the amplifiers in the beam-forming network, and the amplifiers in the RF front-ends are configured such that the signal from a certain direction has the highest gain. The direction in which the signal has the maximum gain can he tuned by varying the phase shifts (or delays) of the phase shifters (or delay elements) and the gains of the amplifiers in the beam-forming network, and/or the gains of the RF front-ends. Thus, the input beam formed by the antenna array can be steered in space.

Furthermore, the phase shifters (or delay elements) and the amplifiers in the beam-forming network, and the amplifiers in the RF front-ends can be configured such that the signals from two or more different directions have much higher gains than the signals from other directions. Thus, the receiver forms two or more antenna beams to receive signals from two or more directions in space.

In another embodiment, the phase shifters (or delay elements) and the amplifiers in the beam-forming network, and the amplifiers in the RF front-ends can be configured such that the signals at the output ports of the beam-forming network have maximum gain from different directions in space. As a result, the space solid-angle is divided into sub-sections (or beams), and the signal incident on each of these sub-sections is processed by the RF front end and the beam-forming network, and appears at one of the output ports of the beam-forming network. In other words, the antenna array generates several simultaneous input beams to receive signals from different directions in space.

A direct benefit of the above method is that the number of beams can be larger than the number of input antennas, resulting in fewer RF front-ends and hence lower power consumption and chip area for the receiver array.

The receiver may further include a digital processing unit, that calibrates the direction of the incoming signal by configuring the phase shifts (or delays) of the phase shifters (or delay elements) and the gains of the amplifiers in the beam-forming network, and/or the gains of the RF front-ends. The digital processing unit may also include the capability to remove the correlation among signals incident from different directions in the space.

The phased array receiver can be formed completely or partially on one or more integrated circuit chips/substrates, including but not limited to, silicon (CMOS), silicon-germanium (SiGe CMOS/BiCMOS), silicon-on-insulator (SOI CMOS), GaAs, InGaAs, InP, and silicon-on-sapphire. Implementation on a silicon substrate can provide the highest level of integration. To achieve even smaller receiver footprint, the antennas may be located on the same die, or in the same package as the receiver. Furthermore, additional passive and active components may be included in the package, including but not limited to, matching networks, amplifiers and multi-throw switches.

The thermal sensitivity performance of the imager, as quantified by the noise-equivalent temperature difference (NETD), can be significantly degraded due to losses in front of the chip, especially for a silicon chip since the receiver noise figure is typically higher than III-V implementations. Therefore, pre-receiver losses must be minimized, Typically, the RF pads of the receiver are bonded to a high-frequency substrate (alumina/ceramic, quartz, Rogers) using ribbon bonds. The substrate may contain feed lines to the transitions to waveguide flanges or horn antennas. For silicon implementations, the ribbon-bond lengths must be minimized to minimize the loss. Alternatively, a flip-chip implementation can be used to further reduce the pre-receiver loss, since flip-chip bumps can be shorter than 100 um and have well-defined and repeatable characteristics. The receiver chip with flip-chip bumps on the pads is attached to a high-frequency substrate with bumps corresponding to the bumps on the chip. The RF bumps are then connected to waveguide flange or horn antenna transitions through transmission feed lines on the same substrate. The feed lines may have additional features such as stubs to tune the frequency response of the receiver module. The lower frequency analog and digital signals to or from the flip-chip assembly can be routed either to a multi-pin connector on the same substrate or to a low-frequency substrate (FR4, BT) through wirebonds, The entire assembly can be enclosed in a. metal housing or on a waveguide split-block module, This packaging method is especially suitable for receivers operating in the spectrum of 30-300 GHz.

The aforementioned receiver can be used for various applications at frequencies ranging from 2 GHz to 300 GHz. It is highly suitable for use at millimeter-wave (mm-wave) frequencies, especially in the extremely high frequency (EHF) spectrum from 30-300 GHz, including 20-30 GHz (K band), 50-70 GHz (V band), 70-110 GHz (W band), 140 GHz (D band) and 220 GHz (G band). These receivers can be used for wireless communication, automotive radars, active/passive imaging and other applications.

A phased array transmitter having beam-forming capability can be realized using the beam-forming network described earlier. The number of input ports of the beam-forming network can be the same as or higher than the number of output ports of the transmitter (and the beam-forming network). The transmitter can optionally include a plurality of RF front-ends, each comprising an RF amplifier chain. The input of each of the RF front-ends is electrically connected to a separate output of the beam-forming network, and the output of each of the RF front-ends is electrically connected to a separate antenna.

The gains of the RF front-ends may be fixed or independently tunable (variable). The gains may be tunable continuously using an analog control signal or in discrete steps using digital control signals. Each of the inputs of the beam-forming network may be electrically connected to additional circuits, including but not limited to, amplifiers, up-converting mixers and modulators.

In one embodiment of the phased array transmitter, the phase shifters (or delay elements) and the amplifiers in the beam-forming network, and the amplifiers in the RE front-ends are configured such that the signal transmitted in a certain direction has the highest power. The direction in which the transmitted signal has the maximum power can be tuned by varying the phase shifts (or delays) of the phase shifters (or delay elements) and the gains of the amplifiers in the beam-forming network, and/or the gains of the RF front-ends. Thus, the output beam formed by the antenna array can be steered in space.

Furthermore, the phase shifters (or delay elements) and the amplifiers in the beam-forming network, and the amplifiers in the RF front-ends can be configured such that the signals in two or more different directions have much higher powers (or amplitudes) than the signals in other directions. Thus, the transmitter forms two or more antenna beams transmitting signals in two or more directions in space.

In another embodiment, the phase shifters (or delay elements) and the amplifiers in the beam-forming network, and the amplifiers in the RF front-ends are configured such that the signals at the output ports of the transmitter have maximum powers (or amplitudes) in different directions in space. As a result, the space solid-angle is divided into sub-sections (or beams), and the signal at each of the input ports of the beam-forming network is processed by the RF front end and the beam-forming network, and is transmitted through one of the sub-sections in space. In other words, the antenna array generates several simultaneous output beams to transmit signals in different directions in space.

A direct benefit of the above method is that the number of beams can be larger than the number of output antennas, resulting in fewer RF front-ends and hence lower power consumption and chip area for the transmitter array.

The transmitter may further include a digital processing unit, that calibrates the direction of the radiated signal by configuring the phase shifts (or delays) of the phase shifters (or delay elements) and the gains of the amplifiers in the beam-forming network, and/or the gains of the RF front-ends. The digital processing unit may also include the capability to remove the correlation among signals radiated in different directions in the space.

The phased array transmitter can be formed completely or partially on one or more integrated circuit chips/substrates, including but not limited to, silicon (CMOS), silicon-germanium (SiGe CMOS/BiCMOS), silicon-on-insulator (SOI CMOS), GaAs, InGaAs, InP, and silicon-on-sapphire. Implementation on a silicon substrate can provide the highest level of integration. To achieve even smaller transmitter footprint, the antennas may be located on the same die, or in the same package as the transmitter, Furthermore, additional passive and active components may be included in the package, including but not limited to, matching networks, amplifiers and multi-throw switches.

The aforementioned transmitter can be used for various applications at frequencies ranging from 2 GHz to 300 GHz. It is highly suitable for use at millimeter-wave (mm-wave) frequencies, especially in the extremely high frequency (EHF) spectrum from 30-300 GHz, including 20-30 GHz (K band), 50-70 GHz (V band), 70-110 GHz (W band), 140 GHz (D band) and 220 GHz (G band). These transmitters can be used for wireless communication, automotive radars, active imaging and other applications.

Using the aforementioned phased array receiver, a passive or active imaging receiver array can be realized, where the signal at each output port of the beam-forming network generates a unit pixel in the image. Furthermore, the number of pixels in the image can be the same as or higher than the number of antennas.

Similarly, an active imaging transceiver array can be implemented using the phased array receiver and the phased array transmitter described hereto. The transmitter radiates signals in different directions in space simultaneously, that are reflected from the target object and are subsequently incident on the receiver array, which generates a unit pixel at each of the output ports of the beam-forming network in the receiver. Again, the number of pixels in the image can be the same as or higher than the number of antennas.

Using the above multi-pixel imaging receiver or transceiver architectures, a large number of pixels can be generated using a small number of antennas 21. This reduces the size, weight, power and cost of the imaging systems, as fewer antennas, RF front-ends, and other components, are required as compared to traditional ager architectures.

Traditional imager architectures, specifically in the EHF spectrum, can be classified into two main categories: (a) staring array imagers, that consist of one receiver element per pixel, and (b) scanned array imagers, that consist of a linear or two-dimensional receiver array (consisting of a small number of elements) that is scanned (either mechanically or electronically) to generate the entire image. These architectures are bulky and expensive due to either a large number of electronic components (staring arrays) or additional mechanical components (scanned imagers). Furthermore, staring array imagers can achieve better thermal sensitivities (or NETD) than scanned imagers, since the dwell time per pixel is larger.

FIG. 1B is a block diagram illustrating an exemplary embodiment of a passive imaging receiver array in accordance with the present invention. The passive imaging receiver array is capable of generating N simultaneous pixels with M antennas 1, where N may be much larger than M, by generating N simultaneous beams in space. In this embodiment, the receiver array comprises M low noise amplifiers (LNAs) 2, a multi-beamforming network 3, N power detectors 4, post-detection amplifiers and filters 5, a single or multiple analog-to-digital converters 6 and digital signal processor 7. Support circuitry includes array calibration circuit 9, clock 10, calibration circuit 11, and digital control 12. Furthermore, the system may include methods and algorithms for calibrating the phased array and for forming multiple beams in space.

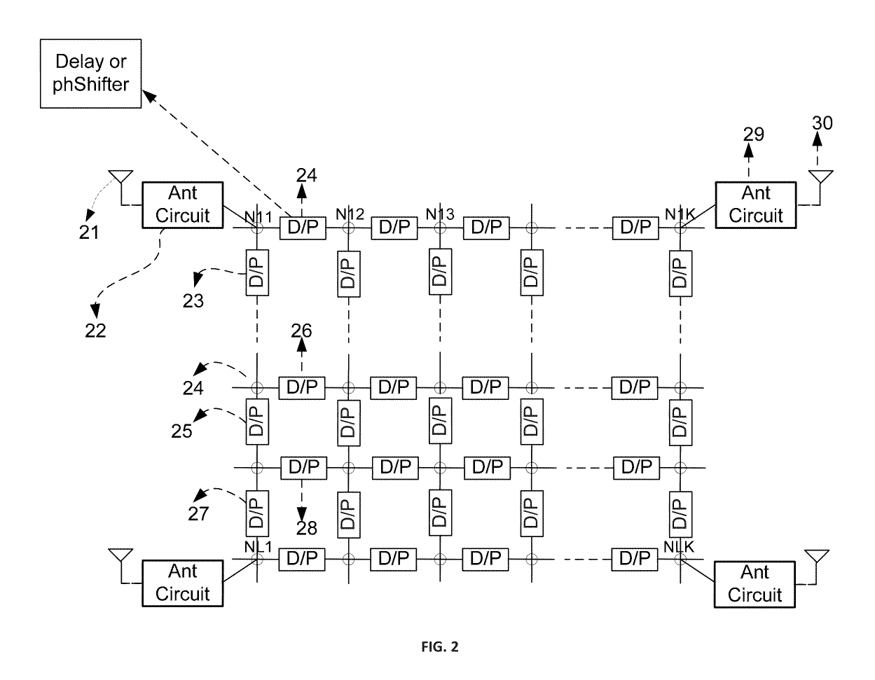

FIG. 2 is a schematic illustrating an exemplary embodiment of a 4-antenna receiver in accordance with the present invention. The receiver consists of four antennas 21 or 30, each followed by an antenna circuit (or RE front-end) 22 or 29. An exemplary embodiment of the beamforming network is also shown. The network is formed by a two-dimensional mesh of phase shifters (or delay elements) 23. The network takes inputs from the four antenna circuits; the output ports of the network are located at each of the nodes 24, 25 and 27 in the two-dimensional mesh. Each of these outputs corresponds to a different input beam direction in space. The number of outputs and hence the number of beams can be changed by changing the size of the mesh.

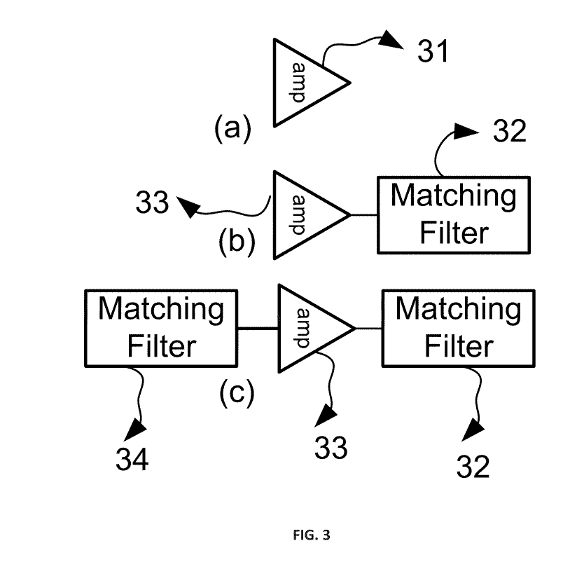

FIG. 3 shows schematics illustrating several exemplary embodiments of the RF front-end in FIG. 2, in accordance with the present invention. FIG. 3 shows several exemplary embodiments of the antennas circuit (RF front-end) of FIG. 2, It may consist of simply an RF amplifier 31, with its output connected to a matching network/filter 32. Its input may be connected to another matching network 34. Furthermore, several amplifiers 33 and matching networks may be cascaded together to achieve higher gains and bandwidths.

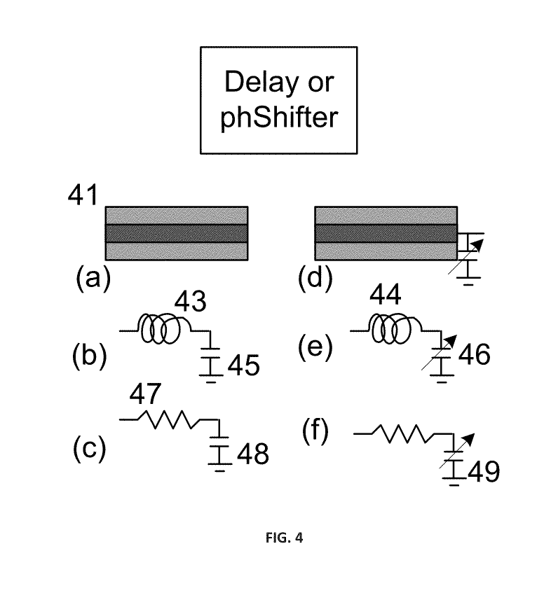

FIG. 4 shows several exemplary embodiments of the phase shifter (or delay element) in FIG. 2. It may be formed as a simple transmission line, an L-C circuit, an R-C circuit. These implementations will provide fixed phase shifts. To realize tunable phase shift, a tunable (variable) capacitor may be added to the end of the transmission line, or the capacitors in the L-C and R-C networks may be replaced with tunable capacitors. Depending on the implementation, the capacitance (and hence the phase shift) may be changed continuously by applying an analog voltage, or in discrete steps using digital control.

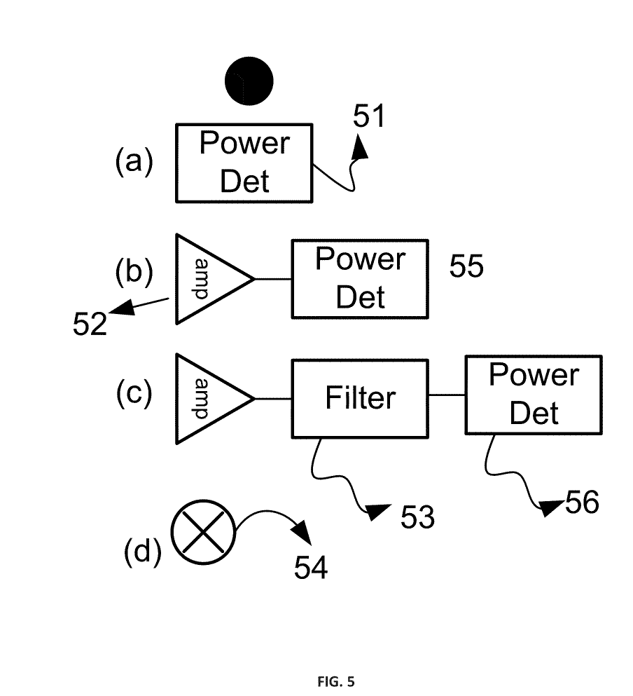

FIG. 5 shows schematics illustrating several exemplary embodiments of the circuits connected to the labeled nodes of the circuit network in FIG. 2, in accordance with the present invention. In FIG. 5, the power detector 51 can operate stand alone. Alternatively, amplifier 52 can drive power detector 55. Another embodiment has the amplifier driving filter 53 that in turn drives the power detector 56. In another embodiment, multiplier 54 can be used.

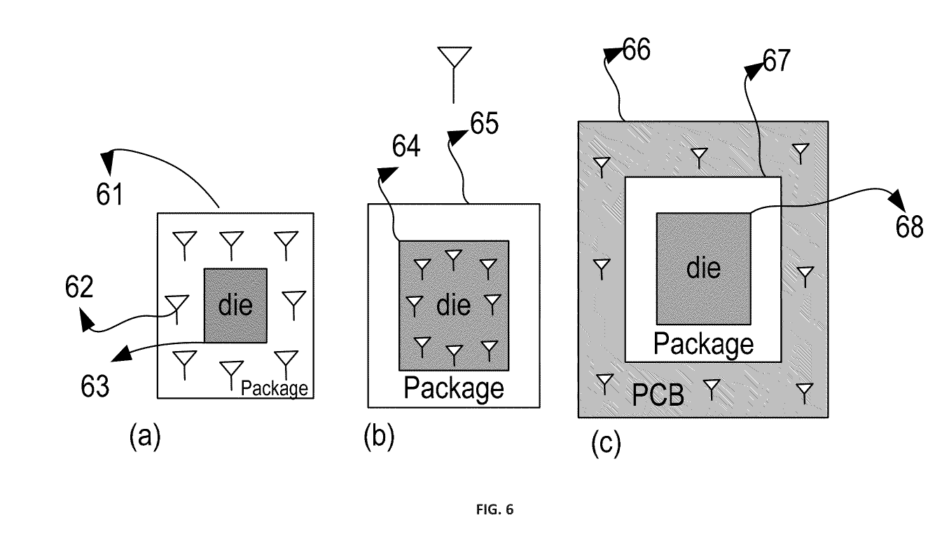

FIG. 6 shows schematics illustrating several exemplary embodiments of the physical arrangement of the semiconductor die and antennas in the package and PCB, in accordance with the present invention.

FIG. 6 shows several exemplary embodiments of the physical arrangement of an integrated receiver or transmitter or transceiver, in accordance with the present invention. The antennas 62 may be integrated in the same package as the integrated circuit chip 63, or on the printed circuit board 61 on which the packaged chip is attached. In another embodiment, the antennas may be integrated within the integrated circuit chip.

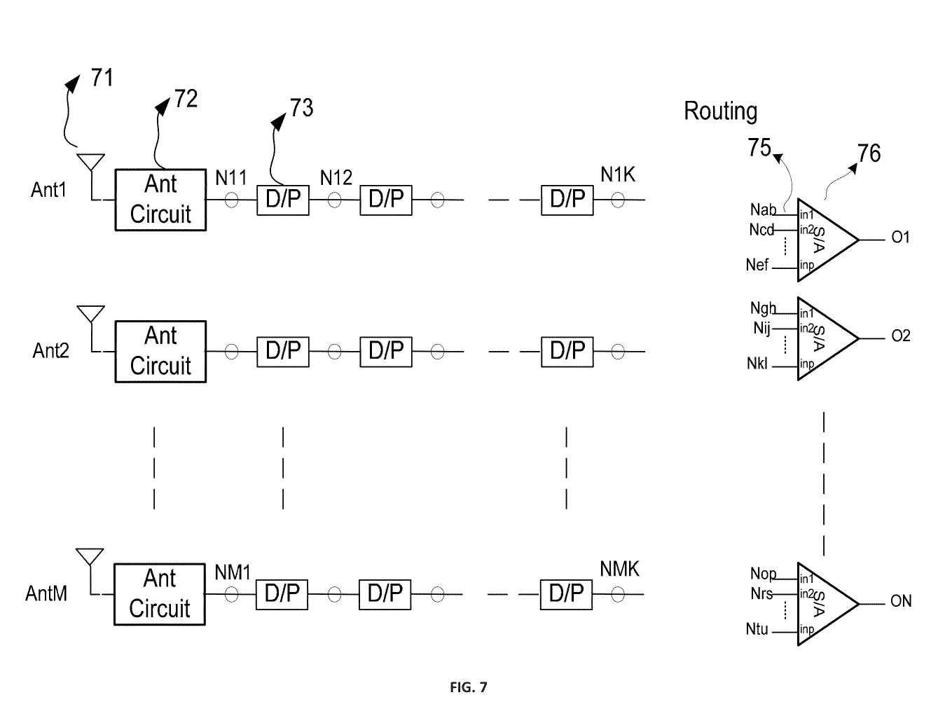

FIG. 7 is a schematic illustrating an exemplary embodiment of a phased array receiver in accordance with the present invention. FIG. 7 shows another embodiment of a receiver array, in accordance with the present invention. The receiver consists of multiple (M) antennas 71, and each antenna is connected to an antenna circuit (or RF front-end) 72. The beam-forming network is formed by a combination of active and passive elements. Each antennas circuit is followed by a linear array of phase shifters or delay elements) 73. The signal Ootputs at various nodes 75 in the phase shifter arrays are applied to several summing amplifiers 76 that generate the N outputs of the beam-forming network.

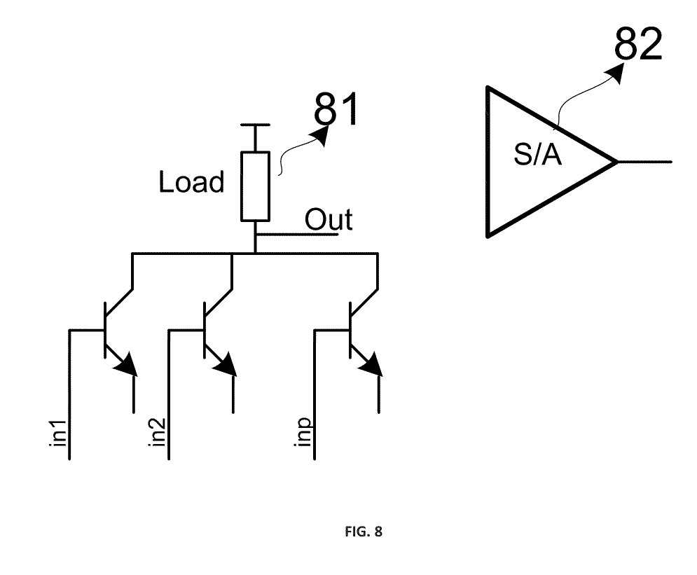

FIG. 8 is a schematic illustrating an exemplary embodiment of the summing amplifier in FIG. 7. FIG. 8 shows an exemplary embodiment of the summing amplifiers 82 in FIG. 7. The inputs are applied to the base terminals of several transistors, and the collector terminals are tied together and connected to a load 81.

Furthermore, the components of the above mentioned system may be implemented on one semiconductor die or on multiple dice. In a highly integrated solution, the die may include:

a. Phase shifter/delay element network.

b. In addition to (a), the single die solution may also include the additional amplifiers before the phase-shifter/delay element network.

c. In addition to (a) or (b), the integrated die solution may also include an amplifier after the phase-shifter/delay-element network

d. In addition to (c), the integrated die may also include a power detector, or a peak detector, or an rms detector, or an envelope detector after the amplifier mentioned in (c), or the phase-shifter/delay-element network described in (a).

e. The integrated die may also include additional amplifiers, filters, or integrators after the block mentioned in (d).

f. In additions to the above mentioned blocks, the integrated die may also include analog to digital convertors to provide the digital output.

g. In addition to the above mentioned blocks, the integrated die may also include supporting circuits and functions such as bias, clock generator, serial or parallel digital control blocks, RF, analog, or digital IO's.

Some of the blocks, dice, and components of the system described herein may be integrated in a single chip/die package.

a. The single chip/die package may include a die/chip with the network of phase-shifters/delay-elements

b. The single chip/die package may include additional amplifiers before the die/chip with the network of phase-shifters/delay-elements

c. The single chip/die package may also include antennas.

d. The single chip/die package may also include matching structures and components.

It should be noted that the components of above described architectures may be implemented on the same semiconductor process/ substrate or on different semiconductor (processes/substrates. In particular, all or some of the system components may be implemented silicon CMOS processes, SiGe processes and/or III-V processes.

The above systems can receive and/or transmit wireless signals in order to enable various applications, including wireless communication, radar operation, and active/passive imaging. These serve as exemplary embodiments of the invention; one with average skill in the art will recognize that other variations on the usage of the principles presented here can be easily derived, and are within the scope of this invention. The imager architectures described herein can operate as a scanned array imager by utilizing only one beam. But more notably, it can generate all the pixels simultaneously by utilizing the multiple beams in all directions, with the same thermal sensitivities as staring array imagers, but without any of the drawbacks associated with them.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A phased array receiver having beam-forming capability, with M inputs and N outputs, comprising:
a. M radio-frequency (RF) front-ends, each comprising an RF amplifier; and
b. a beam-forming network, with M input ports and N output ports, each coupled to at least one of the other ports through an electrical network, and wherein a signal at each port has a predetermined phase or delay relative to the signals at the other ports, and wherein M is smaller than or equal to N.

2. The receiver of claim 1, wherein each electrical network comprises:
a. one or more phase-shifters or delay elements with fixed or variable phase shift or delay; and
b. one or more power combiners or splitters.

3. The receiver of claim 2, wherein each electrical network further comprises one or more amplifiers with fixed or variable gain.

4. The receiver of claim 1, wherein each of the RF front-end output is coupled to a separate input of the beam-forming network.

5. The receiver of claim 1, wherein the RF front-end gains are fixed or independently tunable and wherein the gains are tunable continuously using an analog control signal or discretely using digital control signals.

6. The receiver of claim 2, wherein the phase shifters (or delay elements) in the beam-forming network, and the amplifiers in the RF front-ends are configured such that the gain of the received signal at each output port of the beam-forming network is highest in one of N unique directions in space.

7. The receiver of claim 6, wherein the N directions of the received signals with maximum gain are tuned by varying
a. phase shills (or delays) of the phase shifters (or delay elements) in the beam-forming network; and
b. gains of the RF front-ends.

8. The receiver of claim 6, further comprising a digital processing unit, that calibrates the directions of the received signals and removes the correlation among signals received from different directions, by configuring
a. phase shifts (or delays) of the phase shifters (or delay elements) in the beam-forming network, and
b. gains of the RF front-ends.

9. The receiver of claim 1, wherein the receiver is formed on an integrated circuit chip.

10. The receiver of claim 1, wherein the receiver is mounted on a high-frequency substrate through flip-chip technology, said high-frequency substrate comprising:
a. feed lines connected to the F inputs of the receiver; and
b. transitions from the feed lines to waveguide flanges.

11. A phased array transmitter having beam-forming capability, with N inputs and M outputs, comprising:
a. M radio-frequency (RF) front-ends, each comprising an RF amplifier; and
b. a beam-forming network, with N input ports and M output ports, each coupled to at least one of the other ports through an electrical network, and wherein a signal at each port has a predetermined phase or delay relative to the signals at the other ports, and wherein M is smaller than or equal to N.

12. The transmitter of claim 11, wherein each electrical network comprises:
a. one or more phase-shifters or delay elements with fixed or variable phase shift or delay; and
b. one or more power combiners or splitters.

13. The transmitter of claim 12, wherein each electrical network further comprises one or more amplifiers with fixed or variable gain.

14. The transmitter of claim 11, wherein the input of each of the RF front-ends is coupled to a separate output of the beam-forming network.

15. The transmitter of claim 11, wherein the gains of the RF front-ends are fixed or independently tunable and wherein the gains are tunable continuously using an analog control signal or discretely using digital control signals.

16. The transmitter of claim 12, wherein the phase shifters (or delay elements) in the beam-forming network, and the amplifiers in the RF front-ends are configured such that the gain of the transmitted signal at each output port of the beam-forming network is highest in one of N unique directions in space.

17. The transmitter of claim 16, wherein the N directions of the transmitted signals with maximum gain can be tuned by varying
a. phase shifts (or delays) of the phase shifters (or delay elements) in the beam-forming network; and
b. gains of the RF front-ends.

18. The transmitter of claim 16, further comprising a digital processing unit, that calibrates the directions of the transmitted signals and removes the correlation among signals transmitted in different directions, by configuring
a. phase shifts (or delays) of the phase shifters (or delay elements) in the beam-forming network, and
b. gains of the RF front-ends.

19. The transmitter of claim 11, wherein the transmitter is formed on an integrated circuit chip.

20. The transmitter of claim 11, wherein the transmitter is mounted on a high-frequency substrate through flip-chip technology, said high-frequency substrate comprising:
a. feed lines connected to the RF outputs of the transmitter; and
b. transitions from the feed lines to waveguide flanges.

21. An imaging receiver array comprising the phased array receiver of claim 6, wherein the signal at each output port of the beam-forming network corresponds to a single pixel in the image, and wherein N pixels associated with N outputs of the beam-forming network are generated simultaneously while receiving signals from M antennas coupled to the M inputs of the receiver.

22. The imaging receiver of claim 21, further comprising N power detector circuits, each connected to one of the N output ports of the beam-forming network, to generate an output voltage proportional to the power received at the corresponding port.

23. The imaging receiver of claim 21, wherein the receiver is formed on an integrated circuit chip.

24. A method, comprising the steps of:
a. transmitting signals in different directions in space simultaneously; and
b. receiving reflected signals from different directions in space simultaneously.

25. The method of claim 24, further comprising the step of generating an image pixel corresponding to each of the directions in which a signal is received.
